(19) United States
(12) Patent Application Publication
(10) Pub. No.: US 2023/0419018 A1
(43) Pub. Date: Dec. 28, 2023

(54) AUTOMATIC STATE ASSIGNMENT TO DOCUMENTS BASED ON PHRASE OCCURRENCE IN TEXT

(71) Applicant: Concord III, LLC, Seattle, WA (US)

(72) Inventor: Matthew A. Overlund, Brentwood, TN (US)

(73) Assignee: Concord III, LLC, Seattle, WA (US)

(21) Appl. No.: 17/847,152

(22) Filed: Jun. 22, 2022

(51) Int. Cl. G06F 40/169; G06V 30/19; G06F 40/279; G06F 40/205

(52) U.S. Cl. CPC G06F 40/169; G06F 40/205; G06F 40/279; G06V 30/19

(57) ABSTRACT

Fuzzy document state assignment includes loading into memory a raster image of a document and performing OCR upon a page of a document in order to produce parseable text. The parseable text is then segmented and normalized and an index is generated from the segmented and normalized text. Thereafter, a probability of a particular classification is computed based upon the detection in the index of a combination of words associated with a corresponding classification. Finally, the document is annotated with the particular classification.

### BACKGROUND OF THE INVENTION

### Field of the Invention

The present invention relates to the technical field of document workflow management and more particularly to the assignment of state to a document in a document workflow.

### Description of the Related Art

Text analysis refers to the digital processing of an electronic document in order to understand the context and meaning of the sentences included therein. Traditional text analysis begins with a parsing of the document to produce a discrete set of words. Thereafter, different techniques can be applied to the set of words in order to identify sentences or phrases and to ascertain a meaning of each of the sentences. Traditionally, parts-of-speech analysis and natural language processing (NLP) may be applied in the latter instance in order to determine potential meaning for each of the sentences. Finally, the determined for each of the sentences meaning may be composited into an overall document classification and characterization, such as indicating a nature or topic of the document and a specific notion in respect to the topic.

The exchange of an electronic document between two parties often times is a simple matter of transmitting a digital representation of the document over a communications network, by electronic messaging, direct network pipe, or facsimile messaging. However, in many instances, the document has state in that the processing of the document by the recipient depends upon the state of the document indicative of the necessity of document review by one or more individuals, the processing of the document by one or more processes, or the necessity of a particular timing in the review of the document.

Heretofore, determining the state of an electronic document is a matter of manual understanding in which a recipient reviewer visually inspects the document itself, once completely received, and makes a manual determination based upon the individual knowledge and experience of the recipient. However, in a bulk facsimile messaging environment, the entirety of a document is not received at once as the transmission speed of fax transmission oftentimes exceeds the capability of a fax endpoint to render the complete document, or vice versa. As well, different recipients may interpret the required state of a document differently depending upon the experience of each recipient thus producing inconsistent state classifications. As a result, critical state determinations such as urgency or routing can be inaccurately determined.

### BRIEF SUMMARY OF THE INVENTION

Embodiments of the present invention address technical deficiencies of the art in respect to the classification of a state of a document in a document workflow. To that end, embodiments of the present invention provide for a novel and non-obvious method for the automated assignment of state to a document based upon a phrase occurrence in text of the document—namely, fuzzy document state assignment. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for fuzzy document state assignment includes loading into memory a raster image of a document and performing optical character recognition (OCR) upon a page of a document in order to produce parseable text. The method additionally includes text segmenting and normalizing the parseable text and generating an index of the text segmented and normalized parseable text. The method yet further includes computing a probability of a particular classification based upon detecting in the index a combination of words associated with a corresponding classification. Finally, the method includes annotating the document with the particular classification.

In one aspect of the embodiment, the document includes multiple pages. As such, the process of performing the OCR, generating the index, computing the probability and annotating the document repeats for each of the multiple pages. Further, the annotation of the document based upon performing the process for a first one of the pages is displayed in a display screen of a computer before completing a performance of the process for a second one of the pages. In another aspect of the embodiment, the document is annotated with the computed probability as a confidence of the particular classification. In yet another aspect of the embodiment, the parseable text and the raster image are transmitted with an electronic message to an inbox for second level review of the particular classification. Finally, in even yet another aspect of the embodiment, the computation of the probability is based upon a threshold number of words in the index present in a classification table association the words with the corresponding classification.

In another embodiment of the invention, a data processing system is adapted for fuzzy document state assignment. The system includes a host computing platform with one or more computers, each with memory and one or processing units including one or more processing cores. The system also includes a fuzzy document state assignment module. The module includes computer program instructions enabled while executing in the memory of at least one of the processing units of the host computing platform to load into the memory a raster image of a document, perform OCR upon a page of a document in order to produce parseable text, text segment and normalize the parseable text, generate an index of the text segmented and normalized parseable text, compute a probability of a particular classification based upon detecting in the index a combination of words associated with a corresponding classification and annotate the document with the particular classification.

In this way, the technical deficiencies of the classification of state of an electronically received facsimile document are overcome owing to the uniform treatment of each incrementally received portion of the document based upon the determined presence of the previously indexed combination of terms, normalized from the raw OCR text of the received portion, while ensuring that the state determination can occur even before the entirety of the electronic document has been received at the facsimile endpoint. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of fuzzy document state assignment;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for fuzzy document state assignment. In accordance with an embodiment of the invention, rasterized representations of electronic documents, such as facsimile documents, are converted to text using an OCR process on a page-wise basis, providing the capability to process partial documents as they are received or are made available to the system. The resulting text is segmented, and processed as a set of text regions that are normalized and evaluated against phrases of interest that are correlated to known document states. Phrase matching is performed using a fuzzy-matching and scoring technique to produce a match decision and confidence score. Matching phrases are evaluated against a minimum required confidence threshold, and located phrases satisfying the threshold are processed to assign the associated document state to the source document. Further search for previously matched phrases may be circumvented or repeated as required by the process owning the document, i.e. where frequency of occurrence has meaningful value or not.

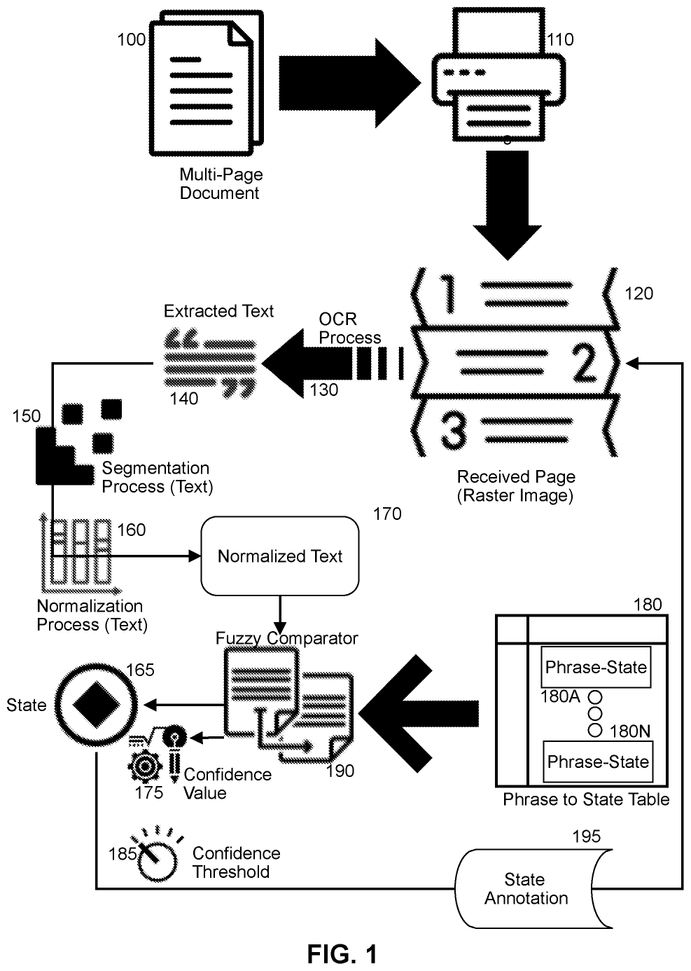

In illustration of one aspect of the embodiment, FIG. 1 pictorially shows a process of fuzzy document state assignment. As shown in FIG. 1, a multi-page document 100 is received in fax machine 110 and converted, page by page, into raster imagery 120. An OCR process 130 converts the raster imagery 120 of each page into extracted text 140 which is subjected to a segmentation process 150 followed by a normalization process 160 in order to produce normalized text 170. A fuzzy comparator 190 then compares different phrases in the normalized text 170 to a phrase to state table 180 containing records 180A, 180N associating different phrases with different document states such as a temporal state (urgent, normal processing), review state (enhanced review required, normal review required) or routing state (route to a particular process). The fuzzy comparator 190 matches the normalized text to a record 180A, 180N in the phrase to state table 180 at least partially so as to produce a confidence 175 of matching of a specific state 165. To the extent that the confidence 175 exceeds a confidence threshold value 185, an annotation 195 of the state 165 is affixed to the raster imagery 120 of the page.

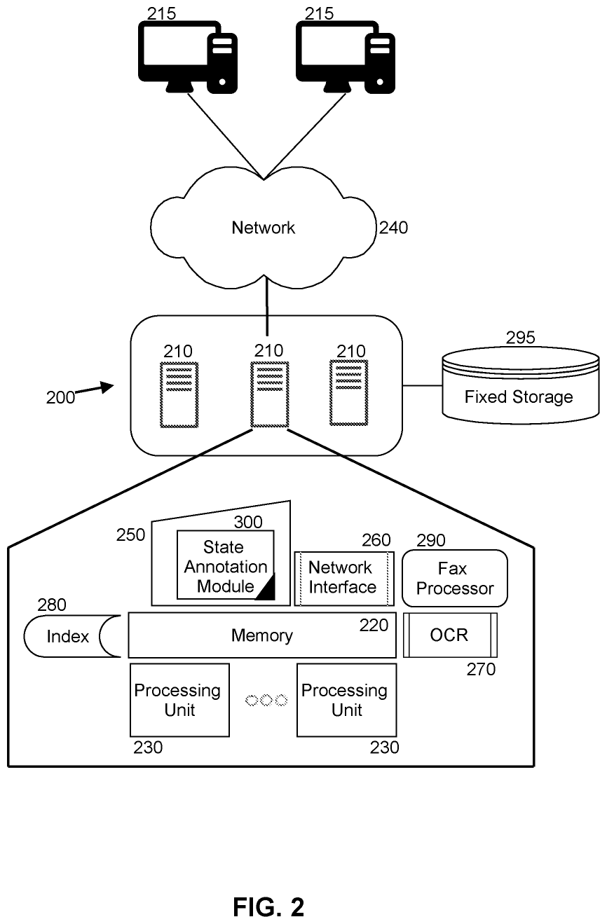

Aspects of the process described in connection with FIG. 1 can be implemented within a data processing system. In further illustration, FIG. 2 schematically shows a data processing system adapted to perform fuzzy document state assignment. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240. The host computing platform further can be communicatively accessed by different client computers 215 from over data communications network 240.

A fax processor 290 is included in the host computing platform 200. The fax processor 290 is enabled to receive a fax document transmission and produce a raster image of each page of the document. To that end, the host computing platform 200 also includes an OCR processor 270 enabled to perform OCR upon the raster imagery of the received fax document. Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for fuzzy document state assignment.

Specifically, the program instructions during execution subjects the extracted text from the OCR processor 270 processing raster imagery of a fax document to a segmentation and normalization process to produce normalized text. The program instructions then match different terms in the normalized text to phrases in a phrase to state index 280. Upon detecting a threshold match of the terms to an entry in the index 280, the program instructions annotate the raster imagery of the fax document with the corresponding state of the threshold matching record in the index 280. Finally, the program instructions store the annotated raster imagery in the fixed storage 295.

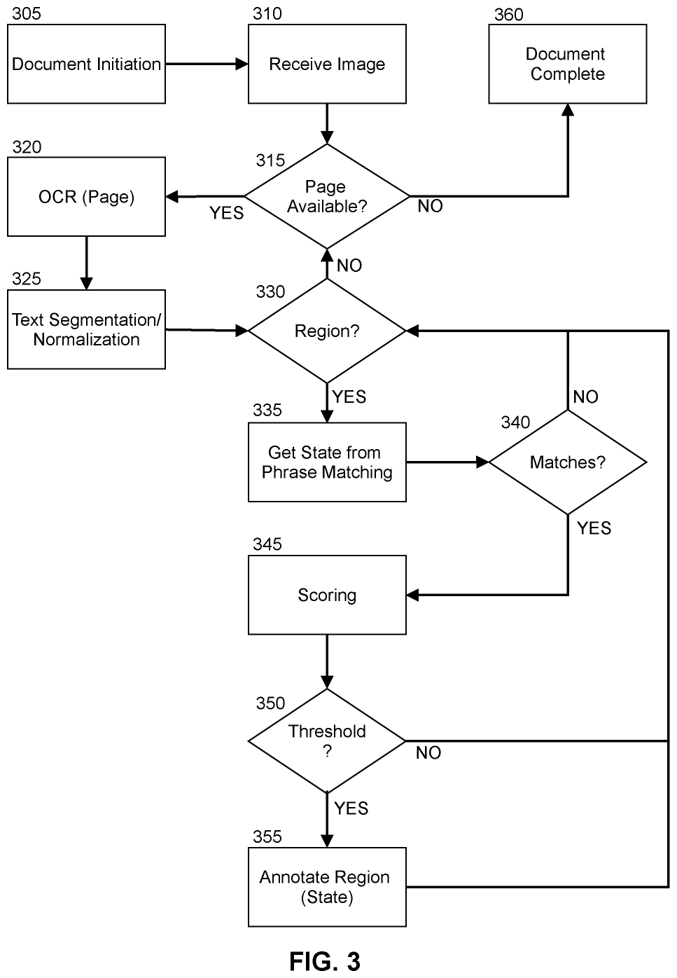

In further illustration of an exemplary operation of the module, FIG. 3 is a flow chart illustrating one of the aspects of the process of FIG. 1. Beginning in block 305, the receipt of a fax document initiates and in block 310, an image of the document is received. In decision block 315, it is determined if a complete page is available for processing. If so, in block 320, the page is subjected to OCR subsequent to which the resultant text is processed in block 325 according to text segmentation and text normalization. In decision block 330, if a relevant textual region is identified in the normalized text, in block 335, phrase matching is performed upon the normalized text of the text region in order to determine if a match can be found in a corresponding index of phrase-to-state records. In decision block 340, if no match is found, the process returns to decision block 330. But otherwise, the process moves to block 345. In block 345, the normalized text found to phrase match a record in the index is scored according to a probability of a complete match. In decision block 350, if the probability exceeds a threshold value, then in block 355 the relevant textual region is annotated with the state corresponding to the matching record entry in the index.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for fuzzy document state assignment comprising:
loading into memory a raster image of a document;
performing optical character recognition (OCR) upon a page of a document in order to produce parseable text;
text segmenting and normalizing the parseable text;
generating an index of the text segmented and normalized parseable text;
computing a probability of a particular classification based upon detecting in the index a combination of words associated with a corresponding classification; and,
annotating the document with the particular classification.

2. The method of claim 1, wherein the document comprises multiple pages and the process of performing the OCR, generating the index, computing the probability and annotating the document repeats for each of the multiple pages.

3. The method of claim 2, wherein the annotation of the document based upon performing the process for a first one of the pages is displayed in a display screen of a computer before completing a performance of the process for a second one of the pages.

4. The method of claim 1, further comprising annotating the document with the computed probability as a confidence of the particular classification.

5. The method of claim 1, further comprising transmitting the parseable text and the raster image with an electronic message to an inbox for second level review of the particular classification.

6. The method of claim 1, wherein the computation of the probability is based upon a threshold number of words in the index present in a classification table association the words with the corresponding classification.

7. A data processing system adapted for fuzzy document state assignment, the system comprising:
a host computing platform comprising one or more computers, each with memory and one or processing units including one or more processing cores; and,
a fuzzy document state assignment module comprising computer program instructions enabled while executing in the memory of at least one of the processing units of the host computing platform to perform:
loading into the memory a raster image of a document;
performing optical character recognition (OCR) upon a page of a document in order to produce parseable text;
text segmenting and normalizing the parseable text;
generating an index of the text segmented and normalized parseable text;
computing a probability of a particular classification based upon detecting in the index a combination of words associated with a corresponding classification; and,
annotating the document with the particular classification.

8. The system of claim 7, wherein the document comprises multiple pages and the process of performing the OCR, generating the index, computing the probability and annotating the document repeats for each of the multiple pages.

9. The system of claim 7, wherein the annotation of the document based upon performing the process for a first one of the pages is displayed in a display screen of a computer before completing a performance of the process for a second one of the pages.

10. The system of claim 7, wherein the program instructions further perform annotating the document with the computed probability as a confidence of the particular classification.

11. The system of claim 7, wherein the program instructions further perform transmitting the parseable text and the raster image with an electronic message to an inbox for second level review of the particular classification.

12. The system of claim 7, wherein the computation of the probability is based upon a threshold number of words in the index present in a classification table association the words with the corresponding classification.

13. A computing device comprising a non-transitory computer readable storage medium having program instructions stored therein, the instructions being executable by at least one processing core of a processing unit to cause the processing unit to perform a method for fuzzy document state assignment, the method including:
loading into memory a raster image of a document;
performing optical character recognition (OCR) upon a page of a document in order to produce parseable text;
text segmenting and normalizing the parseable text;
generating an index of the text segmented and normalized parseable text;
computing a probability of a particular classification based upon detecting in the index a combination of words associated with a corresponding classification; and,
annotating the document with the particular classification.

14. The device of claim 13, wherein the document comprises multiple pages and the process of performing the OCR, generating the index, computing the probability and annotating the document repeats for each of the multiple pages.

15. The device of claim 14, wherein the annotation of the document based upon performing the process for a first one of the pages is displayed in a display screen of a computer before completing a performance of the process for a second one of the pages.

16. The device of claim 13, wherein the method further includes annotating the document with the computed probability as a confidence of the particular classification.

17. The device of claim 13, wherein the method further includes transmitting the parseable text and the raster image with an electronic message to an inbox for second level review of the particular classification.

18. The device of claim 13, wherein the computation of the probability is based upon a threshold number of words in the index present in a classification table association the words with the corresponding classification.
